(19) United States
(12) Patent Application Publication
(10) Pub. No.: US 2025/0015585 A1
(43) Pub. Date: Jan. 9, 2025

(54) ELECTRICAL DEVICE

(71) Applicant: HELLA GmbH & Co. KGaA, Lippstadt (DE)

(72) Inventor: Martin TRINSCHEK, Hamm (DE)

(73) Assignee: HELLA GmbH & Co. KGaA, Lippstadt (DE)

(21) Appl. No.: 18/893,870

(22) Filed: Sep. 23, 2024

Related U.S. Application Data
(63) Continuation of application No. PCT/EP2023/056221, filed on Mar. 10, 2023.

(30) Foreign Application Priority Data
Mar. 22, 2022 (DE) 10 2022 106 698.3

(51) Int. Cl. H02H 5/04

(52) U.S. Cl. CPC H02H 5/04

(57) ABSTRACT

An electrical device including an input and/or an output having at least one first terminal each and one second terminal each. For reducing the current across the first terminal, at least one further first terminal electrically in parallel to the first terminal and for reducing the current across the second terminal, at least one further second terminal electrically in parallel to the second terminal. The terminals are assigned a temperature sensor that detects the temperature of the device in an area of the respective terminals.

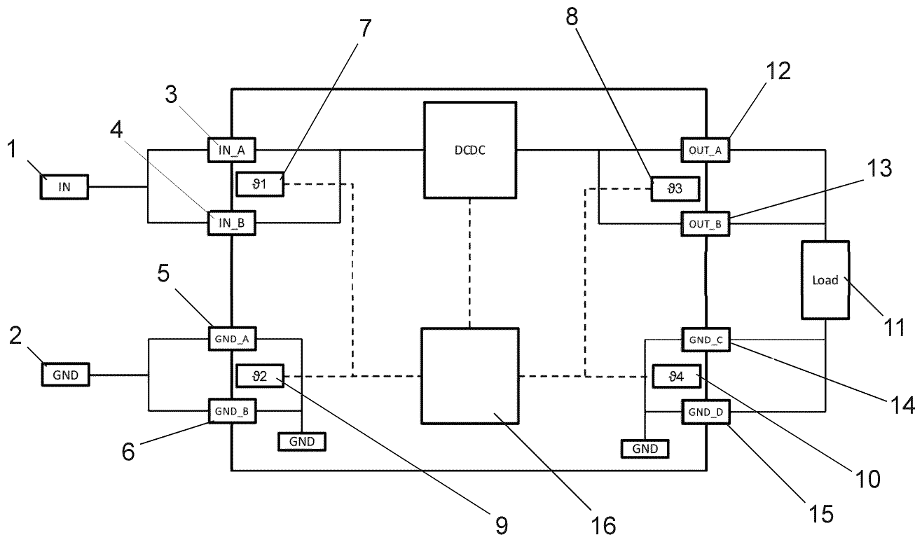

This nonprovisional application is a continuation of International Application No. PCT/EP2023/056221, which was filed on Mar. 10, 2023, and which claims priority to German Patent Application No. 10 2022 106 698.3, which was filed in Germany on Mar. 22, 2022, and which are both herein incorporated by reference.

### BACKGROUND OF THE INVENTION

### Field of the Invention

The invention relates to an electrical device, in particular a control unit, sensor, or actuator for a motor vehicle, including an input and/or an output having at least
one first terminal each and
one second terminal each and
for reducing the current across the first terminal, at least one further first terminal electrically in parallel to the first terminal and
for reducing the current across the second terminal, at least one further second terminal electrically in parallel to the second terminal.

### Description of the Background Art

It is known to reduce an electric current across a terminal or a line by using two or more terminals or lines guided in parallel instead of one terminal or one line, so that the current is divided over two or more parallel terminals or lines. Overload of an individual terminal or of an individual line may thus be avoided. Although terminals or lines that are loadable with higher currents could be used, this is often not possible for practical reasons, or would result in higher costs than when the terminals and lines are designed in duplicate.

However, a problem may arise if the electrical resistance increases at one of the parallel terminals, or if the connection across one of the parallel contacts is interrupted. This results in a higher current across the possible single remaining terminal or the possible single remaining line, which is thus overloaded. The overload may result in damage to the device or beyond, which must be avoided.

The invention addresses this problem.

### SUMMARY OF THE INVENTION

The object of the invention is to alter an electrical device in such a way that an overload of one of at least two parallel terminals is recognized before damage occurs.

This object is achieved according to the invention in that the first terminals of the input are assigned a first temperature sensor that detects the temperature of the device in the area of the first terminals of the input and/or the first terminals of the output are assigned a second temperature sensor that detects the temperature of the device in the area of the first terminals of the output and/or the second terminals of the input are assigned a third temperature sensor that detects the temperature of the device in the area of the second terminals of the input and/or the second terminals of the output are assigned a fourth temperature sensor that detects the temperature of the device in the area of the second terminals of the output.

It is known from the document DE 11 2018 006 079 T5, which corresponds to US 2019/0162603, which is incorporated herein by reference, to monitor the temperature of a terminal using a temperature sensor, since resistance heating, also referred to as Joule heating or ohmic heating, occurs at individual locations such as transitions and/or junctions, for example, which connect components of an electric vehicle charging device and an electric vehicle. In addition, the resistance heating at these locations may increase due to various parameters or conditions, for example manufacturing tolerances, mechanical aging and reduction of the contact pressure, chemical corrosion or oxidation of connecting surfaces, or improper use and misuse, which result in impaired performance. Increased resistance may potentially lead to overheating of and damage to the components of the electric vehicle charging device and/or the electric vehicle during operation.

The document DE 11 2018 006 079 T5 teaches the monitoring of the temperature of an individual terminal. However, since an electrical device of the type mentioned at the outset has at least four terminals, namely, at least two first terminals and at least two second terminals, according to the teaching of the document DE 11 2018 006 079 T5 a total of at least four temperature sensors would be necessary. If not just two, but even three, terminals are connected in parallel, according to the teaching of the document DE 11 2018 006 079 T5 six temperature sensors are necessary. If the device has an input and output, each with two first and two second parallel terminals, eight terminals would each be assigned a temperature sensor. The more terminals that are present, the more temperature sensors that are needed according to the teaching of the document DE 11 2018 006 079 T5 to monitor the terminals, which is very complicated.

Therefore, the inventors have taken a different approach. According to the invention, it is not the temperature of individual terminals that is monitored, but, rather, the temperature of the terminals connected in parallel. If increased temperature of a parallel circuit is determined by temperature monitoring of the terminals connected in parallel, it may not be possible to make a statement about which terminal is the heat source that is resulting in the increased temperature. However, it is generally sufficient to determine which of the parallel circuits is affected. Further checking and subsequent maintenance or repair of the affected terminals connected in parallel is then possible, and results in elimination of the cause of the heat generation. By monitoring terminals connected in parallel, it is possible to reduce the number of temperature sensors.

According to the invention, it is possible to monitor only the temperatures of the terminals of one input or multiple or all inputs, of one output or multiple or all outputs, of one input and one output, of one input and multiple or all outputs, of multiple or all inputs and one output, of multiple inputs and multiple or all outputs, of multiple or all inputs and multiple outputs or of all inputs and all outputs.

A device according to the invention may have a housing, the terminals being provided in the housing in order to connect the device to a power supply network, in particular to a vehicle electrical system or to other electrical devices.

A device according to the invention may also have an electronic circuit that is connected to the temperature sensor(s), and that is suitable for evaluating a signal of the temperature sensor or of each of the temperature sensors. The electronic circuit may include a memory that stores one or more reference values for allowable temperatures in the area of the terminals connected in parallel. Each terminal connected in parallel may be assigned an individual reference value. It is likewise possible to assign a reference value to all parallel circuits or some parallel circuits of terminals.

A device according to the invention may also have a further temperature sensor that is connected to the circuit or that is part of the circuit. This further temperature sensor may be used to detect a temperature of the circuit or in the housing. This measured temperature may likewise be used as a reference value.

The circuit of a device according to the invention may have an evaluator via which the at least one temperature, measured by the temperature sensor situated in the area of the at least one terminal connected in parallel, may be compared to the reference value(s) and/or to the temperature measured by the further temperature sensor. If the comparison shows that the at least one temperature, measured by the temperature sensor situated in the area of the at least one terminal connected in parallel, is higher than the assigned reference value or the temperature measured by the further temperature sensor, this may indicate heavy or excessive load on one of the terminals that requires intervention.

The evaluator may be used to generate a signal when, in at least one area of one of the terminals connected in parallel, a temperature is present that is too high compared to the stored reference value(s) or compared to the temperature measured by the further temperature sensor.

A device according to the invention may have a display device, connected to the evaluator, for displaying an excessively high temperature. The display device may be an optical or acoustic display device. A device according to the invention may also have an interface via which the signal indicating an excessively high temperature may be transmitted to other locations, in particular in a motor vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole FIGURE shows a block diagram of a device according to the invention.

### DETAILED DESCRIPTION

The illustrated device according to the invention has an input 3, 4, 5, 6 and an output 12, 13, 14, 15. The input has two first terminals 3, 4 connected in parallel and two second terminals 5, 6 connected in parallel. The input is connected to a vehicle electrical system. The first terminals are connected to the positive potential 1 of a vehicle electrical system voltage, and the second terminals are connected to the ground potential of the vehicle electrical system.

The output likewise has two first terminals 12, 13 connected in parallel and two second terminals 14, 15 connected in parallel. A load 11 is connected to the output.

The terminals 3, 4, 5, 6 of the input and the terminals 12, 13, 14, 15 have a parallel design so that the input and the output may be loaded with currents that would be too high for simply designed terminals having the same construction.

The device has a direct current converter DCDC between the first terminals of the input and the first terminals of the output. The direct current converter DCDC is controlled by an electronic circuit 16. The DCDC converter is one example; one or more switches or some other circuit could possibly be used instead.

To prevent overload in the event of a high-impedance failure of one of the terminals of the terminals connected in parallel, which then has to conduct the entire amount or at least a greater portion of the current, temperature sensors 7, 8, 9, 10 that monitor the temperature in the area of the terminals 3, 4; 5, 6; 12, 13; 14, 15 connected in parallel are placed for monitoring the terminals in the immediate vicinity of the terminals configured in parallel. The temperature sensors 7, 8, 9, 10 are connected to the circuit 16. The number of temperature sensors 7, 8, 9, 10 is a function of the number and the positioning of the terminals 3, 4; 5, 6; 12, 13; 14, 15 to be monitored. If one of the parallel terminals 3, 4; 5, 6; 12, 13; 14, 15 has failed, the current will flow across the other terminal. This increased current consumption will result in an increase in the temperature in this area, which may be detected by the temperature sensor 7, 8, 9, 10 that is assigned to this area.

Based on the comparison of the available temperatures, the electronic circuit 16 of the device can recognize that a terminal is defective and respond as specified, for example generating a signal which reduces the power transported from the input, across the direct current converter DCDC, to the output, and which thus reduces the currents or switches off the load 11.

A fixed threshold value for the temperatures may, but does not have to, be selected as a comparative value. Instead, a maximum temperature difference may be selected as a comparative value, which is compared to temperature differences from temperatures measured in the system. Thus, even at low temperatures a defect in the connection may be recognized and reported.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrical device comprising:
an input having a first terminal, a second terminal, and at least one further first terminal electrically in parallel to the first terminal for reducing the current across the first terminal; and
an output having a first terminal, a second terminal, and at least one further second terminal electrically in parallel to the second terminal for reducing the current across the second terminal,
wherein the first terminals of the input are assigned a first temperature sensor that detects the temperature of the device in an area of the first terminals of the input,
wherein the first terminals of the output are assigned a second temperature sensor that detects the temperature of the device in an area of the first terminals of the output,
wherein the second terminals of the input are assigned a third temperature sensor that detects the temperature of the device in an area of the second terminals of the input, and/or
wherein the second terminals of the output are assigned a fourth temperature sensor that detects the temperature of the device in an area of the second terminals of the output.

2. The electrical device according to claim 1, wherein the device has a housing, the terminals being provided in the housing in order to connect the device to a power grid or to a vehicle electrical system or to other electrical devices.

3. The electrical device according to claim 1, wherein the device has an electronic circuit that is connected to the temperature sensor(s) and that is suitable for evaluating a signal of the temperature sensor or of each of the temperature sensors.

4. The electrical device according to claim 3, wherein the electronic circuit includes a memory that stores one or more reference values for allowable temperatures in the area of the terminals connected in parallel.

5. The electrical device according to claim 3, wherein the device has a further temperature sensor that is connected to the circuit or that is part of the circuit, and wherein this further temperature sensor is used to detect a temperature of the circuit or in the housing.

6. The electrical device according to claim 3, wherein the circuit has an evaluator via which the temperatures measured by the temperature sensors arranged in parallel are compared to the reference value(s) and/or to the temperature measured by the further temperature sensor.

7. The electrical device according to claim 6, wherein the evaluator generates a signal when, in at least one area of one of the terminals connected in parallel, a temperature is present that is too high compared to the stored reference value(s) or compared to the temperature measured by the further temperature sensor.

8. The electrical device according to claim 7, wherein the device has a display connectable to the evaluator, for displaying an excessively high temperature.

9. The electrical device according to claim 1, wherein electrical device is a control unit, sensor, or actuator for a motor vehicle.
